(19) United States
(12) Patent Application Publication
(10) Pub. No.: US 2019/0332697 A1
(43) Pub. Date: Oct. 31, 2019

(54) DATABASE SCHEMA VALIDATIONS

(71) Applicant: Hewlett-Packard Development Company, L.P., Houston, TX (US)

(72) Inventors: Kevin WILLIAMS, San Diego, CA (US); Amit Kumar SINGH, Houston, TX (US); Gaurav ROY, Houston, TX (US)

(21) Appl. No.: 15/963,318

(22) Filed: Apr. 26, 2018

(51) Int. Cl. G06F 17/30

(52) U.S. Cl. CPC G06F 17/30294; G06F 17/30371; G06F 17/30569

(57) ABSTRACT

An example of an apparatus a network interface to receive a first dataset and a second dataset, wherein the first dataset is associated with the second data set is provided. The apparatus further includes a query engine to generate a first schema from the first dataset and a second schema from the second dataset, wherein the first schema and the second schema are in a common format. The apparatus includes a validation engine to generate a matrix for comparison of data transformations, wherein the matrix includes the first schema and the second schema in the common format. The validation engine is to compare the first schema and the second schema to validate of the second dataset.

### BACKGROUND

Data may be stored in computer-readable databases. These databases may store large volumes of data collected over time. Processing large databases may be inefficient and expensive. Computers may be used to retrieve and process the data stored in databases.

### BRIEF DESCRIPTION OF THE DRAWINGS

Reference will now be made, by way of example only, to the accompanying drawings in which:

FIG. 1 is a block diagram of an example apparatus to validate datasets;

FIG. 2 is a flowchart of an example of a method to validate datasets;

FIG. 3 is a flowchart of another example of a method to generate a schema;

FIG. 4 is a block diagram of another example apparatus to validate datasets;

FIGS. 5A-B is an example of a schema table and dataset table;

FIGS. 6A-B is an example of a schema table and dataset table with a data transformation to a datatype;

FIGS. 7A-B is an example of a schema table and dataset table with a data transformation to a datatype; and

FIGS. 8A-B is an example of a schema table and dataset table with a data transformation to a column label.

### DETAILED DESCRIPTION

Increasing volumes of data create increased complexity when storing, manipulating, and assessing the data. For example, with increases in the connectively of devices and the number of sensors in the various components of each device making time-series measurements, the generated data is increasingly voluminous and complex.

Accordingly, databases are used to store, retrieve, and manipulate datasets with complex data structures of systems, system components, and component attributes and their corresponding values. For example, limits are placed on databases to balance versatility with efficiency in storing data. When databases are deployed in various applications, demands from the various applications reach the limits placed on the databases. Accordingly, the limits may be modified to accommodate a specific application or use case causing the database associated with the application to evolve over time. This may result in unintentional consequences as the databases from various applications, which may have evolved to be out of original specifications, are subsequently combined later.

As an example, when an organization develops a database in an initial testing stage, the database will be implemented in a staging phase prior to deployment. In this example, the database is not intended to be further modified during the staging phase as final testing is performed. However, demands for an application may result in late changes or data transformations to the database structure that will make it incompatible with the original database structure. Furthermore, such changes are often poorly documented and not communicated back to the original designers, which makes it difficult to diagnose and address. By storing data schema in a matrix as described in greater detail below, a developer will be able to quickly review any changes to the database over time to allow for quick assessment of what may cause a database to no longer be compatible with the original database.

As another example, a database may be deployed to multiple devices, where the database may be stored on the various devices with different database platforms. Similarly, as the devices are used for various applications, the demands of one or more applications may require minor changes or data transformations be made to the database. Accordingly, the databases stored on the devices may evolve to become incompatible over time. By converting the schema of each database into a common format and by storing the schema in a matrix, a developer may be able to quickly review data transformations to the database structure over time to allow for quick assessment of what may cause the databases to no longer be compatible.

In the examples described herein, a common database schema may be implemented to consolidate and simplify the management of multiple devices in an organization. For example, the database may provide a single unified lookup table capable of handling multiple devices that are tracked with multiple formats. That is, the database is capable to be synchronized with other databases such as a master database or multiple other local databases maintained on portable devices. For example, a database may be used locally on a device as a local version of a master database. If the device is replaced with a new device supporting a different database platform, such as through a hardware upgrade, the common database schema will allow the local version of the master database to be transferred to and reused on the new device without a need to regenerate a new local version from the master database.

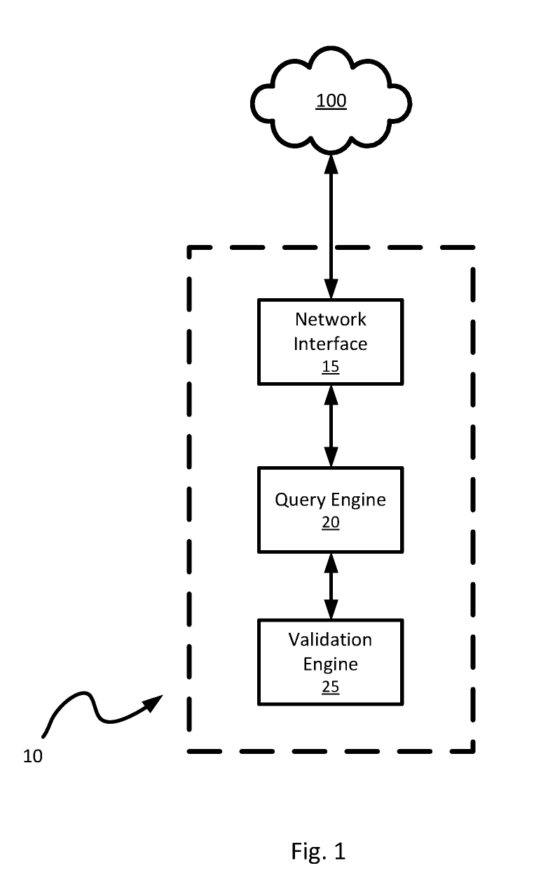

Referring to FIG. 1, an apparatus to validate a dataset is generally shown at 10. The apparatus may include additional components, such as various memory storage units, interfaces to communicate with other computer apparatus or devices, and further input and output devices to interact with a user or another device. In the present example, the apparatus 10 includes a network interface 15, a query engine 20, and a validation engine 25. Although the present example shows the query engine 20 and the validation engine 25 as separate components, in other examples, the query engine 20 and the validation engine 25 may be combined within a processor and may be part of the same physical component such as a microprocessor configured to carry out multiple functions.

The network interface 15 is to receive datasets via a network 100. In the present example, the network 100 may provide a link to another device, such as a client device of a device as a service system to send and receive one or more datasets stored within a database on the device. In other examples, the network 100 may provide a link to multiple devices, such that each device may provide one or more datasets stored on separate databases. The network interface 15 may be a wireless network card to communicate with the network 100 via a WiFi connection. In other examples, the network interface 15 may also be a network interface controller connected to via a wired connection such as Ethernet.

The datasets received are not particularly limited and typically represent data in a database such as a database of companies or customers along with and identifier and a description. In the present example, the datasets received at the network interface 15 are associated with each other. The manner by which the datasets are associated may include datasets of the same database received at different times, or datasets of intended copies or portions of the same database obtained from different sources. For example, the network interface 15 may receive a dataset from the same device on a periodic basis, such as after the passage of a predetermined period of time after the receipt of the previous dataset at the network interface 15. The period of time may be set to any value, such as once an hour, once a day, or once a week.

In another example, the network interface 15 may receive a dataset from the different devices, which is intended to be a copy of the same database. It is to be appreciated that each of the different devices in this example may use a different database platform, such that the datasets may not be easily compared if the raw dataset were to be received from each device.

The query engine 20 is in communication with the network interface 15 and is to generate a schema from each dataset. The manner by which the query engine 20 generates the schemas is not particularly limited. In the present example, the query engine 20 dynamically generates a schema for the dataset via aggregated query results. In particular, the query engine 20 may be used to query the dataset to generate the schemas based on the data within the dataset. In particular, the query engine 20 may determine the column name along with the maximum values, such as string length, for each column and the process may be repeated until all columns within the dataset has been queried. In the present example, the maximum value may be determined by querying the dataset, such as information_schema.columns of a SQL compatible database to obtain this information. In other examples where this query is not permitted or available, the query engine 20 may query each entry to determine the entry with the largest number of characters.

Each schema generated by the query engine 20 is generated in a common format such that schemas based on datasets from different database platforms, which are incompatible with each other, may also be compared. The format in which the schema is to be generated is not particularly limited. In the present example, the query engine 20 generates schemas in a text-based format, such as a text-based table comprising columns that are used to identify a column name and datatype for each dataset. In some examples, the schemas may also include an additional column to identify a maximum value for each entry. In other examples, the maximum values may be included in the datatype information. In other examples, other portable formats may be used to represent the schemas generated by the query engine 20, such as CSV, JSON, and proprietary XML export formats as supported by Oracle, and MS SQL. In further examples, non-portable or proprietary formats may also be used.

The validation engine 25 is in communication with the query engine 20 and is to generate a matrix for comparison of data transformations. In the present example, the matrix generated by the validation engine 25 includes the schemas generated by the query engine 20 in the common format. Continuing with the example above where the schemas associated with each dataset received at the query engine 20 is generated as a text-based table, the matrix generated by the validation engine 25 may be generated by combining all the schemas from the query engine 20 into a large text-based file. In the present example, the query engine 20 may generate multiple schemas from multiple datasets periodically as described above. In such examples, it is to be appreciated that the additional schemas may be continually added to the matrix to generate a log of database activities and data transformations. In particular, the log may include multiple schemas to facilitate identification of schema changes as described in greater detail below.

The manner by which the validation engine 25 generates the matrix of data transformations is not particularly limited. In the present example, the validation engine 25 appends each schema generated by the query engine 20 into a single text file. In addition, the validation engine 25 may add an identification field to the matrix. The identification field is generally used to identify the schemas within the matrix. For example, each schema may be represented as a text-based table with a fixed number of columns. In this example, the validation engine 25 may add an additional column to the matrix to store identifying information. The additional column used as the identification field may be used to store timing information, such as a timestamp associated with the particular schemas within the matrix. Accordingly, it is to be appreciated that multiple schemas may be derived by the query engine 20 of the same database periodically over a course of time. In this example, the timestamp may be used to identify the time at which a specific schema was generated. In other examples, the identification field may be used to store information regarding the source of the dataset, such as the media access control address of the device providing the dataset via the network interface 15.

In the present example, the validation engine 25 is also to validate a dataset received at the network interface 15 by comparing the schema associated with the dataset to the schema associated with a similar dataset that is intended to be the same. The manner by which the dataset is validated is not particularly limited. In the present example, the validation engine 25 compares the contents within the matrix to look for discrepancies between the schema of interest and an earlier version of the schema. For example, the comparison of the two schemas within the matrix may be carried out by a simple SQL query since the matrix is completely text based. It is to be appreciated that in other examples where the matrix may not be a text-based table, the matrix may still be searchable with a SQL query.

The validation of two schemas within the matrix may also be carried out with various SQL commands to be operated on the matrix. For example, SQL may be used to identify the difference between two schemas within the matrix with the JOIN command. This may be carried out on all the schemas stored in the matrix to identify differences. Since the schemas stored within the matrix are from the same dataset originally, the schema is to be identical throughout all schemas stored in the matrix. When a data transformation occurs, a schema within the matrix will be different. Such differences are caught with this SQL search and may be presented in a report along with the data in the identification field to provide for quick audits of data transformations within a specific database and/or multiple databases that were intended to have identical schemas.

Although the present example shows the query engine 20 and the validation engine 25 as separate components, in other examples, the query engine 20 and the validation engine 25 may be part of the same physical component such as a microprocessor configured to carry out multiple functions. In other examples, the query engine 20 and the validation engine 25 may be carried out on separate servers of a server system connected by a network, such as in a cloud computing environment.

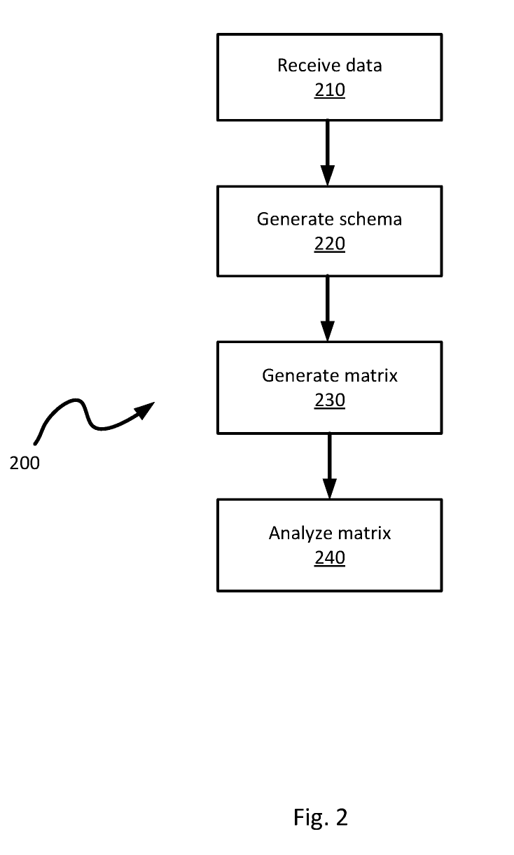

Referring to FIG. 2, a flowchart of an example method to validate a dataset is generally shown at 200. In order to assist in the explanation of method 200, it will be assumed that method 200 may be performed with the apparatus 10. Indeed, the method 200 may be one way in which apparatus 10 may be configured. Furthermore, the following discussion of method 200 may lead to a further understanding of the apparatus 10 and its various components. In addition, it is to be emphasized, that method 200 need not be performed in the exact sequence as shown, and various blocks may be performed in parallel rather than in sequence, or in a different sequence altogether.

Beginning at block 210, the query engine 20 receives a plurality of sets of data. In the present example, each set of data generally represents database content at different times for the same database. In other examples, each set of data may represent database content from different sources with different database platforms to store information in a similar data structure. The content of the data in each set of data is not limited. In an example, the data may include a representation of a company, a unique company identifier, and/or a description of the company. Furthermore, the manner by which the sets of data are received is not particularly limited. For example, the sets of data may be received from an external device to maintain a database as part of an automated or periodic database maintenance process. In other examples, the sets of data may be manually uploaded by a user from an external device.

Block 220 generates a schema from each set of data received at the query engine 20. In particular, each schema is generated in a common format to facilitate comparisons of various schemas, such as when the sets of data originate from different database platforms. The format in which the schema is to be generated is not particularly limited. In the present example, the query engine 20 generates schemas in a text-based format, such as by writing a text file with a table that includes columns used to identify a column name and datatype for each set of data. In some examples, the schemas may also include an additional column to identify a maximum value for each entry. In other examples, the maximum values may be included in the datatype information. In other examples, other portable formats may be used to represent the schemas generated by the query engine 20. In further examples, non-portable or proprietary formats may also be used.

Block 230 generates a matrix with the validation engine 25 from the set of data received at the query engine 20. The matrix is not particularly limited and includes the schema generated from each of the sets of data at block 220. In the present example, each schema is associated with a set of data received at the query engine 20 and generated as a text-based table. Accordingly, the matrix may be generated by combining all the schemas from the query engine 20 into a large text-based file. The manner by which the schemas are combined to generate the matrix is not particularly limited. In the present example, the matrix is generated by simply appending schemas to an initial text-based schema such that a long text file is generated with all the schemas from block 220.

In addition, block 230 may insert an identification field into a text file to represent the matrix. The identification field is generally used to identify the specific schema within the matrix. For example, each schema may be represented as a text-based table with a fixed number of columns. In this example, the validation engine 25 may add an additional column to the matrix to store identifying information. The additional column used as the identification field may be used to store timing information, such as a timestamp associated with the particular schema within the matrix. Accordingly, it is to be appreciated that multiple schemas may be derived by the query engine 20 of the same database periodically over a course of time. In this example, the timestamp may be used to identify the time at which a specific schema was generated. In other examples, the identification field may be used to store information regarding the source of the dataset, such as the media access control address of the device to provide the dataset via the network interface 15.

Next, block 240 analyzes the matrix to validate a set of data originally received at block 210 with another set pf data originally received at block 210. In particular, block 240, carried out by the validation engine 25 compares a schema associated with a set of data against another schema from the matrix.

The application of the method 200 to validate sets of data from one or more databases with a matrix of data transformations may enhance the auditability of databases, such as in a testing environment, where minor changes and data transformations to the database structure may be made to accommodate various applications. In the event that such data transformations or changes are made without proper documentation, the method 200 provides accountability to determine at least a time when such changes were so that appropriate corrective measures may be taken as well as to identify potential issues that may have caused the improper data transformation, such as lack of training or other factors.

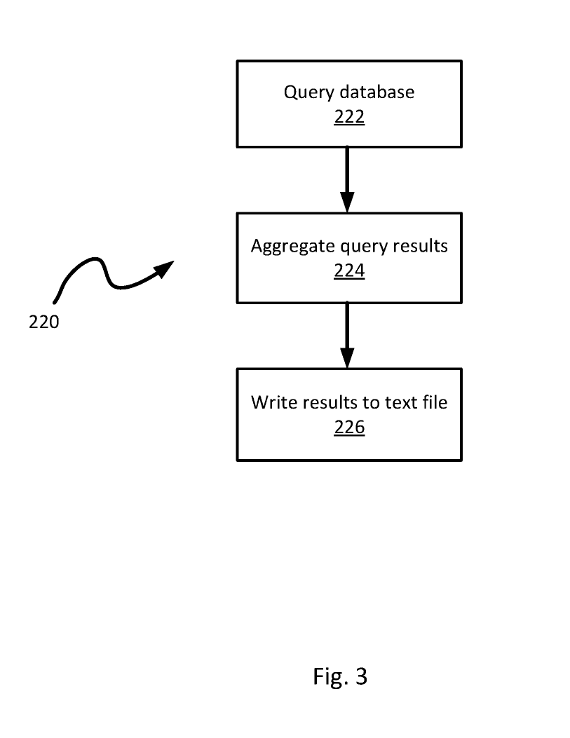

Referring to FIG. 3, a flowchart of an example execution of block 220 to generate a schema from each set of data received at the query engine 20. In order to assist in the explanation of the execution of block 220, it will be assumed that the execution of block 220 may be performed with the query engine 20 subsequent to receiving a set of data from via the network interface 15. The following discussion of execution of block 220 may lead to a further understanding of the apparatus 10 and its various components.

Block 222 queries the set of data received at block 210. The manner by which identification of the query is carried out is not particularly limited. For example, the query engine 20 may dynamically query the set of data to obtain a plurality of query results.

Block 224 aggregates the query results obtained by the execution of block 222. It is to be appreciated that in some examples, block 222 may be carried out with a standard SQL command to run all the queries in the database. Accordingly, such a command may combine the results from the execution of block 222 with the aggregation of block.

Block 226 writes the schema, as determined at block 224 to a text file in the present example. The text file generated may the be subsequently used by the apparatus 10 to generate a matrix and be subjected to additional processing as described in connection with the method 200.

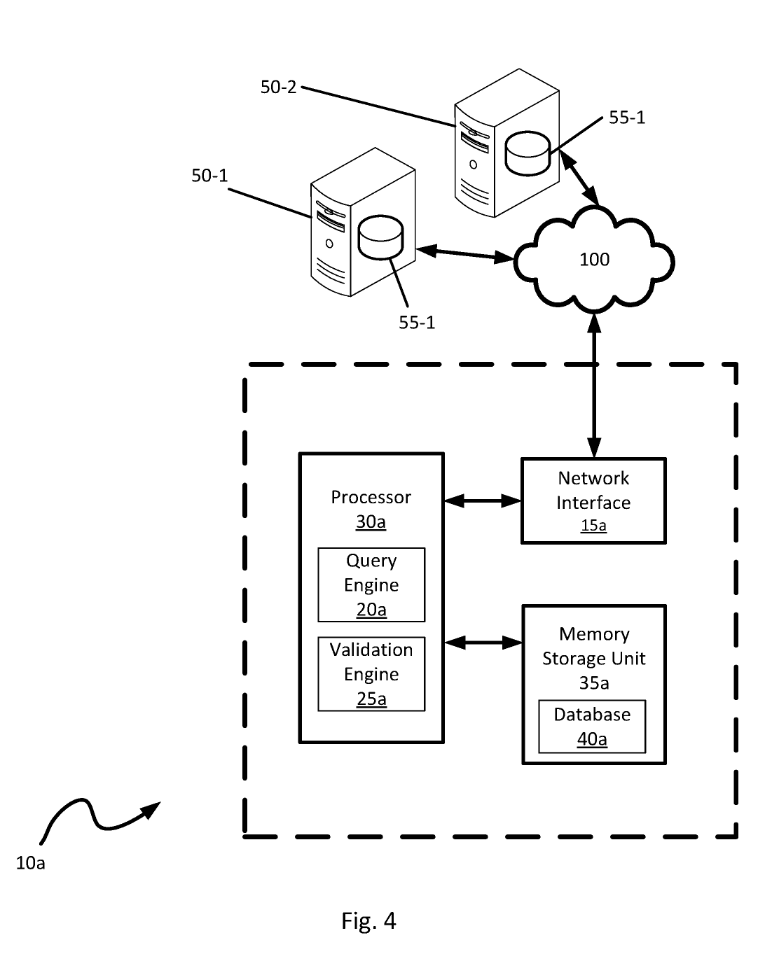

Referring to FIG. 4, another example of an apparatus to validate a dataset is shown at 10a. Like components of the apparatus 10a bear like reference to their counterparts in the apparatus 10, except followed by the suffix “a”. The apparatus 10a includes a network interface 15a, a query engine 20a and a validation engine 25a operated by a processor 30a, and a memory storage unit 35a.

In the present example, the apparatus 10a is to operate a device as a service system. In particular, the device as a service system is an Internet of Things solution, where devices, users, and companies are treated as components in a system that facilitates analytics-driven point of care. In particular, the apparatus 10a manages a plurality of devices 50-1 and 50-2 (generically, these devices are referred to herein as “device 50” and collectively they are referred to as “device 50”, this nomenclature is used elsewhere in this description). In this example, the devices 50 may separately maintain local databases 55-1 and 55-2 to store data. The memory storage unit 35a may also maintain a master database 40a which is to be compatible with the databases 55 to facilitate synchronization.

The network interface 15a is to receive datasets via a network 100. In the present example, the network 100 may provide a link to another device, such as a client device of a device as a service system to send and receive one or more datasets stored within a database on the device. In other examples, the network 100 may provide a link to multiple devices, such that each device may provide one or more datasets stored on separate databases. The network interface 15a may be a wireless network card to communicate with the network 100 via a WiFi connection. In other examples, the network interface 15a may also be a network interface controller connected to via a wired connection such as Ethernet.

In the present example, the network interface 15a receives a dataset from the devices 50 periodically, which are intended to be copies of the same database. It is to be appreciated that each of the different devices 50 in this example may use a different database platform, such that the datasets may not be easily compared if the raw dataset were to be received from each device. Furthermore, the network interface 15a may receive a dataset from each of the devices 50 on a periodic basis, such as after the passage of a predetermined period of time after the receipt of the dataset at the network interface 15a. The period of time may be set to any value, such as once an hour, once a day, or once a week.

The query engine 20a is operated on the processor 30a and is to generate a schema in a text format from each dataset received at the network interface 15a. The manner by which the query engine 20a generates the schemas is not particularly limited. In the present example, the query engine 20a dynamically generates a schema for each dataset via aggregated query results. In particular, the query engine 20a may be used to query each dataset to generate the schemas based on the data within the dataset. In particular, the query engine 20a may determine the column name along with the maximum values, such as string length, for each column and the process may be repeated until all columns within the dataset has been queried.

The validation engine 25a is also operated on the processor 30a and is to generate a table, such as a matrix, for comparison of multiple datasets. In the present example, the table generated by the validation engine 25a includes the schemas generated by the query engine 20a in the text format. Accordingly, the table generated by the validation engine 25a may be generated by combining all the schemas from the query engine 20a into a large text-based file. In the present example, the query engine 20a may generate multiple schemas from multiple datasets periodically as described above. In such examples, it is to be appreciated that the additional schemas may be continually added to the table to generate a log of database activities and data transformations. In particular, the log may include multiple schemas identified as described in greater detail below to provide auditability across the system, particularly during a development phase for the database system.

The manner by which the validation engine 25a generates the table of data transformations is not particularly limited. In the present example, the validation engine 25a appends each schema generated by the query engine 20 into a single text file. In addition, the validation engine 25a may add an identification field to the table. The identification field is generally used to identify the schemas within the table. For example, each schema may be represented as a text-based table with a fixed number of columns. In this example, the validation engine 25a may add an additional column to the table to store identifying information. The additional column used as the identification field may be used to store timing information, such as a timestamp associated with the particular schemas within the table. Accordingly, it is to be appreciated that multiple schemas may be derived by the query engine 20a of the same database periodically over a course of time. In this example, the timestamp may be used to identify the time at which a specific schema was generated. In other examples, the identification field may be used to store information regarding the source of the dataset, such as the media access control address of the device providing the dataset via the network interface 15a.

In the present example, the validation engine 25a is also to identify differences between datasets received at the network interface 15a by comparing the schema associated with each dataset. The manner by which the differences are identified is not particularly limited. In the present example, the validation engine 25a compares the contents within the table to look for discrepancies between the schema of interest and an earlier version of the schema. For example, the comparison of the two schemas within the table may be carried out by a simple SQL query since the table if completely text based. It is to be appreciated that in other examples where the table may not be a text-based table, the table may still be searchable with a SQL query.

The processor 30a is to operate the various engines, such as the query engine 20a and the validation engine 25a. In the present example, the processor 30a is in communication with the network interface 15a as well as the memory storage unit 35a. The processor 30a may include a central processing unit (CPU), a microcontroller, a microprocessor, a processing core, a field-programmable gate array (FPGA), an application-specific integrated circuit (ASIC), or similar. In the present example, the processor 30a may cooperate with a memory storage unit 35a to execute various instructions. For example, the processor 30a may maintain and operate various applications with which a user may interact. In other examples, the processor 30a may send or receive data, such as input and output associated with the dataset.

Although the present example shows the query engine 20a and the validation engine 25a operated on the processor 30a as separate components, the components may be separated and operated on various other components such as via cloud computing as discussed above.

The memory storage unit 35a is configured to receive datasets from via the network interface 15a as well as schema and tables from the query engine 20a and the validation engine 25a. The memory storage unit 35a us also coupled to the processor 30a in general. In the present example, the memory storage unit 35a may include a non-transitory machine-readable storage medium that may be, for example, an electronic, magnetic, optical, or other physical storage device.

In the present example, the memory storage unit 35a is to maintain datasets, schemas and tables or matrices. In addition, the memory storage unit 35a may store an operating system that is executable by the processor 30a to provide general functionality to the apparatus 10. For example, the operating system may provide functionality to additional applications. Examples of operating systems include Windows™, macOS™, OS™, Android™, Linux™, and Unix™. The memory storage unit 35a may additionally store instructions to operate at the driver level as well as other hardware drivers to communicate with other components and peripheral devices of the apparatus 10.

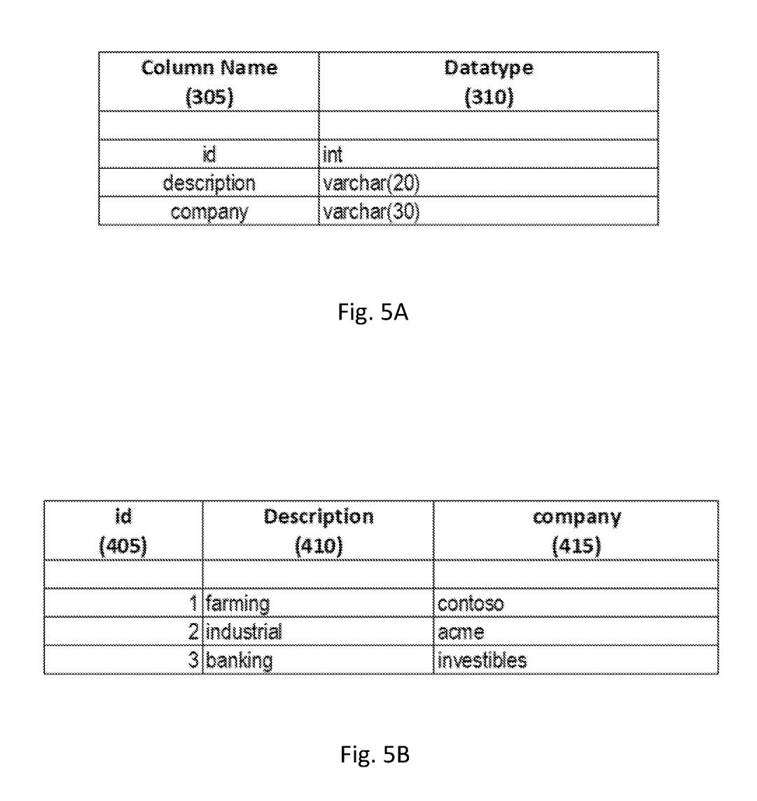

Referring to FIG. 5A, an example of a schema of a database is shown generally in a text-based table form. The discussion of the schema may lead to a further understanding of the apparatus 10 as well as the method 200 and their various components. The schema includes a plurality of columns to store metadata associated with a dataset. In this example, each row of the table in FIG. 5A may represent a record, such as one associated with a company. The columns of the schema include a name column 305 and a datatype column 310.

The name column 305 includes the different fields of the database associated with this specific schema. As shown in FIG. 5A, the name column 305 includes three entries. The exact number of entries (i.e. rows) is FIG. 5A is not particularly limited and that more or less than three rows may be used.

The datatype column 310 includes the type of data that is to be entered into each of the fields identified by a name provided by the name column. As shown in FIG. 5A, the data type INT and VARCHAR are used in the database. The data type INT means that the data stored in the dataset is an integer value. However, the data type VARCHAR is a free text string with a maximum length in characters provided in parenthesis.

Referring to FIG. 5B, an example of a dataset of a database associated with the schema shown in FIG. 5A is shown generally in a text-based table form. The columns of the dataset include an ID column 405, a Description column 410, and a Company column 415.

The ID column 405 includes an ID number assigned to each data record. The manner by which the ID number is assigned is not particularly limited and the ID number may be assigned randomly or in sequence.

The Description column 410 includes string values that describe the company associated with the data record. As shown in FIG. 5A, the maximum length of the string is 20 characters. Accordingly, all the data in the Description column is not to exceed 20 characters, which is illustrated in FIG. 5B.

The Company column 415 includes string values that describe the company associated with the data record. As shown in FIG. 5A, the maximum length of the string is 30 characters. Accordingly, all the data in the Company column is not to exceed 30 characters, which is illustrated in FIG. 5B.

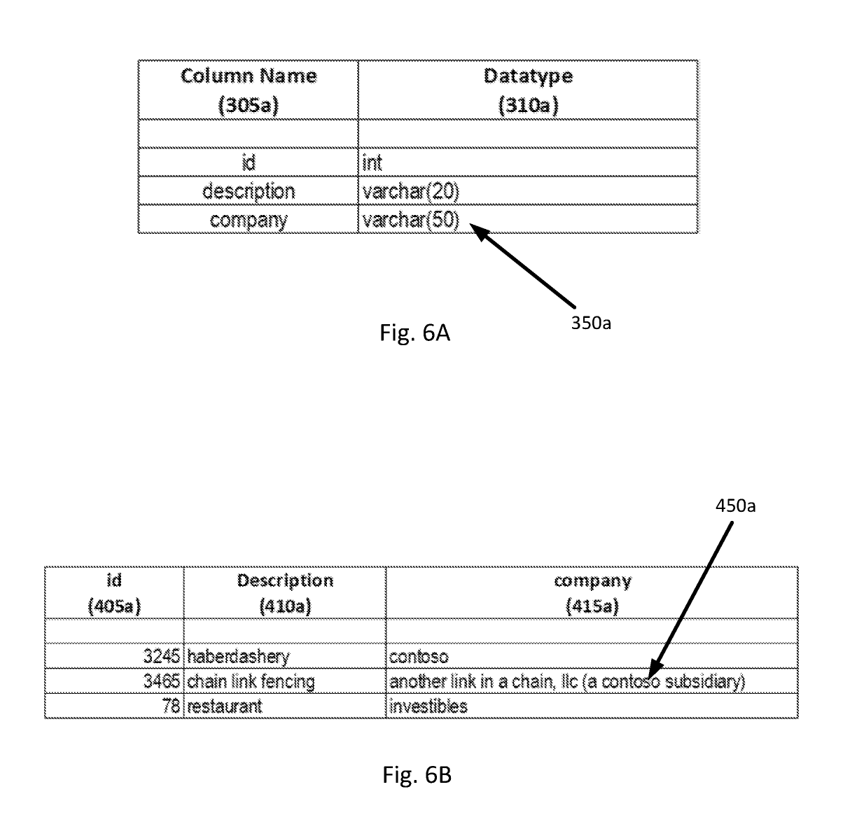

Referring to FIGS. 6A and 6B, an example of a data transformation is generally illustrated. As shown in FIG. 6A, the columns of the text-based schema include a name column 305a and a datatype column 310a. As shown in FIG. 6B, the columns of the dataset include an ID column 405a, a Description column 410a, and a Company column 415a.

In this example, a value in the Company column 415a exceeded the original maximum 30 character limit from FIG. 5A as shown at 450a. In response, a data transformation was carried out on the schema to increase the character limit to 50 characters at 350a. Accordingly, if the dataset shown in FIG. 6B is merged with the dataset of 5B without addressing the change in the width of the Company column 415a, the datasets will not merge properly.

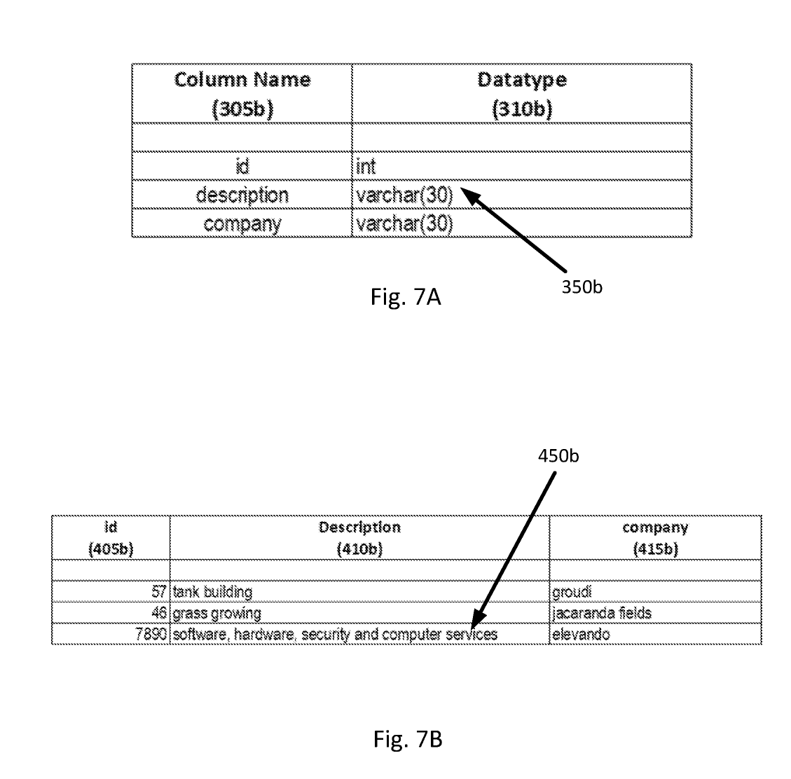

Referring to FIGS. 7A and 7B, an example of a data transformation is generally illustrated. As shown in FIG. 7A, the columns of the text-based schema include a name column 305b and a datatype column 310b. As shown in FIG. 7B, the columns of the dataset include an ID column 405b, a Description column 410b, and a Company column 415b.

In this example, a value in the Description column 410b exceeded the original maximum 20 character limit from FIG. 5A as shown at 450b. In response, a data transformation was carried out on the schema to increase the character limit to 30 characters at 350b. Accordingly, if the dataset shown in FIG. 7B is merged with the dataset of 5B without addressing the change in the width of the Description column 410b, the datasets will not merge properly.

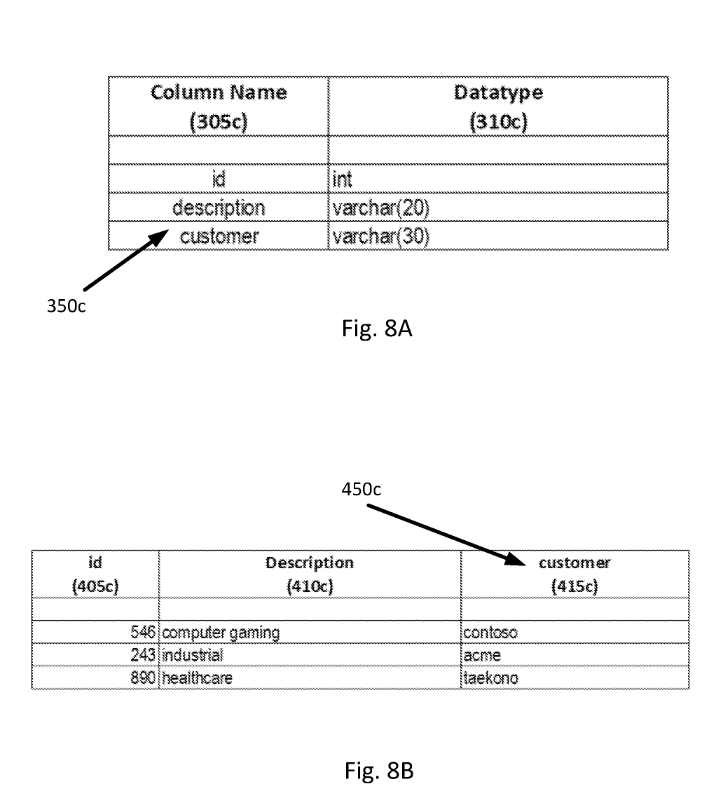

Referring to FIGS. 8A and 8B, an example of a data transformation is generally illustrated. As shown in FIG. 8A, the columns of the text-based schema include a name column 305c and a datatype column 310c. As shown in FIG. 8B, the columns of the dataset include an ID column 405c, a Description column 410c, and a Customer column 415c.

In this example, the Company column 415 from FIG. 5b has had the name of the column in the dataset changed to Customer column 415c. This data transformation was carried out on the schema to likely enhance the accuracy of the label. Although the datatypes and size of each column remains unchanged from the dataset of FIG. 5B, merging the dataset shown in FIG. 8B with the dataset of 5B may result in an incompatibility due to the difference in labels.

It is to be recognized that features and aspects of the various examples provided above may be combined into further examples that also fall within the scope of the present disclosure.

What is claimed is:

1. An apparatus comprising:
a network interface to receive a first dataset and a second dataset, wherein the first dataset is associated with the second data set;
a query engine to generate a first schema from the first dataset and a second schema from the second dataset, wherein the first schema and the second schema are in a common format; and
a validation engine to generate a matrix for comparison of data transformations, wherein the matrix includes the first schema and the second schema in the common format, the validation engine further to compare the first schema and the second schema to validate of the second dataset.

2. The apparatus of claim 1, wherein the first dataset is from a first database platform and the second dataset is from a second database platform, and wherein the first database platform and the second database platform are incompatible.

3. The apparatus of claim 1, wherein the query engine generates the first schema as a first text-based table and generates the second schema as a second text-based table.

4. The apparatus of claim 3, wherein the validation engine combines the first text-based table and the second text-based table to generate the matrix.

5. The apparatus of claim 4, wherein the validation engine adds an identification field to the matrix, wherein the identification field is to identify the first text-based table and the second text-based table.

6. The apparatus of claim 5, wherein the identification field is to store a timestamp.

7. The apparatus of claim 1, wherein the network interface receives the second dataset after a predetermined period of time subsequent to receipt of the first dataset.

8. The apparatus of claim 7, wherein the network interface is to receive additional datasets periodically after each passage of the predetermined period of time to add a plurality of schemas to the matrix to generate a log of database activities.

9. A method comprising:
receiving, via a network interface, a first set of data and a second set of data, wherein the first set of data represents database content at a first time and the second set of data represents the database content at a second time;
generating a first schema from the first set of data and a second schema from the second set of data with a query engine, wherein the first schema and the second schema are in a common format;
generating a matrix for comparison of the first set of data and the second set of data, wherein the matrix includes the first schema and the second schema in the common format; and
analyzing the matrix to validate the second set of data via a comparison of the first schema and the second schema.

10. The method of claim 9, wherein generating the first schema comprises querying the first set of data to write a first text file, and wherein generating the second schema comprises querying the second set of data to write a second text file.

11. The method of claim 10, wherein generating the matrix comprises appending the second text file to the first text file.

12. The method of claim 11, further comprising inserting an identification field in the matrix to identify the first schema and the second schema.

13. The method of claim 12, wherein identification field is populated with a timestamp.

14. A non-transitory machine-readable storage medium encoded with instructions executable by a processor, the non-transitory machine-readable storage medium comprising:
instructions to receive a first dataset and a second dataset, wherein the first dataset is associated with the second data set;
instructions to generate a first schema in text format from the first dataset and to generate a second schema in text format from the second dataset;
instructions to generate a table for comparison of the first dataset and the second dataset, wherein the table includes the first schema and the second schema; and
instructions to identify differences between the first dataset and the second dataset to validate the second dataset.

15. The non-transitory machine-readable storage medium of claim 14, further comprising instructions to receive additional datasets periodically to generate a log of schema changes.
